(19) United States
(12) Patent Application Publication
(10) Pub. No.: US 2003/0032415 A1
(43) Pub. Date: Feb. 13, 2003

(54) Voice announced caller identification features and methods therefor

(76) Inventors: Han S. Cho, Wheaton, IL (US); Thomas G. Mcneela, Waukegan, IL (US)

Correspondence Address: MOTOROLA INC, 600 NORTH US HIGHWAY 45, LIBERTYVILLE, IL, 60048-5343, US

(21) Appl. No.: 09/928,321

(22) Filed: Aug. 13, 2001

(51) Int. Cl. H04M 3/42

(52) U.S. Cl. 455/415; 455/567

(57) ABSTRACT

A method in a mobile wireless communication device (10) including a wireless communication receiver/transmitter (20), a memory (30) for storing a communication address and an audio clip associated therewith, an audio output (60), a processor ((50) coupled to the memory and to the audio output, the processor for playing the audio clip at the audio output when a wireless communication originated from the communication address associated with the audio clip is received by the wireless communication receiver.

### FIELD OF THE INVENTIONS

The present inventions relate generally to mobile wireless communication devices, and more particularly hands-free caller identification features and methods therefor.

### BACKGROUND OF THE INVENTIONS

Many communication service providers plans include offer a call-waiting feature. In operation, when an incoming telephone call is received during a call with another party, the call-waiting feature prompts the party receiving the incoming call with an audible tone to indicate that another call is waiting. The receiving party may then answer the incoming call, for example by depressing the flash key, or disregard it. The call waiting tone is usually at least a couple of times.

Communication service provider plans also offer a caller-ID feature that visually displays the number and in some instances the name of the calling party on a visual display device on or coupled to the phone of party receiving the call.

When a call-waiting signal is generated, it is common for users also having a caller-ID feature to first identify the caller waiting before answering the call. Unwanted calls, for example from solicitors are often ignored.

In cellular handsets having both call-waiting and caller-ID features, during a call, users must remove the cellular handset from their ear to see the name and or number of the caller waiting, since the caller-ID information is displayed on the handset. In a cellular handset having a hands-free kit, for example an ear bud with a microphone, the user must locate and view the cellular handset display to identify the caller waiting.

It is desirable to provide handsfree call-waiting features, especially in mobile wireless communications devices, for example cellular telephones.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is exemplary mobile wireless communication device.

FIG. 2 is a process flow diagram according to the present invention.

### DETAILED DESCRIPTION OF THE INVENTIONS

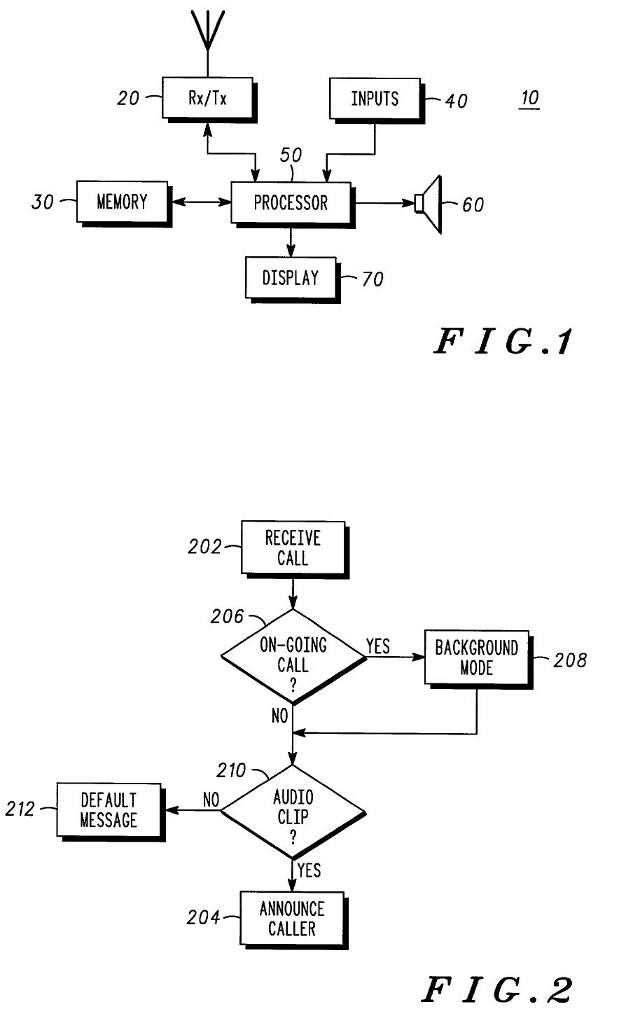

FIG. 1 is an exemplary mobile wireless communication device 10, for example a cellular telephone, or a pager, or a wireless enabled personal digital assistant, or a wireless enabled laptop computer por some other wireless communication device.

The device 10 comprises generally a wireless communication receiver 20 for receiving wireless communications. In other embodiments, except perhaps some pagers, the receiver 20 also includes a transmitter for transmitting wireless communications.

In some embodiments, the device 10 includes a memory 30 for storing one or more communication addresses and corresponding audio clips associated therewith. In cellular wireless handsets, the communication addresses are telephone numbers and the audio clips are names or some other unique indicium associated therewith. In other embodiments, the communication address may be a pager, or an e-mail address, or a network address, including a universal resource locator (URL).

In one embodiment, the audio clips correspond to or are uniquely associated with corresponding communication addresses stored in the communication device. The audio clips are, for example, the communication addresses or the names of the owner or user of the communication addresses.

The uniqueness of the audio clip need extend only to a small universe of communication addresses stored in the device. In other embodiments, the audio clips may be grouped, for example, communications from work related origins are all associated with the same sound clip “work”, communications from home or family origins are all associated with the same sound clip “family”, etc.

The audio clips may be recorded directly at the device or recorded and stored at some other device, like a computer, and then downloaded onto the communications device 10 via an input 40 on the device for storage in memory thereof. The input may be, for example, an infrared port or a hardwire input connector, or a microphone input. The voice clips may also be downloaded onto the device over a wireless interface, for example via packet data communications. In cellular handsets having voice dialing capabilities, the same stored audio clips may be used both for voice dialing and caller announcement features.

The communication device 10 also includes a processor 50 coupled to the memory and to an audio output 60, for example a speaker or a headphone output of the communications device. In another embodiment, the audio output is an audio signal output pin or pins, which may be part of a standard or proprietary electrical connector, connectable to an audio system, for example an automotive stereo sound system via an audiocassette adapter, wherein the audio is played over a sound system separate from the communications device.

The processor 50 plays an audio clip at the audio output 60 when a communication from an address associated with the audio clip is received by the communication device 10. In some embodiments, the communication address and/or some other indicium, like the caller's name, is also displayed on a display 70 of the device.

In the process block diagram of FIG. 2, an incoming communication is received at a mobile wireless communication device at block 202. When the incoming communication is received, at block 204, an audible announcement is provided on an audio output of the mobile wireless communication device associated with the incoming communication, thereby indicating to the user the identity of the communication address or name of the party originating the incoming call.

In some instances, the incoming communication may be received during an on-going communication or call, as often occurs in cellular telephone handsets. To alert the user that a new call is waiting, the audible announcement is provided on the audio output during the on-going communication. As discussed above, the audible announcement uniquely associated with the incoming communication, for example a name associated with the calling party.

During on-going calls, the audible announcement is preferably a relatively quiet background announcement that does not overly distract the user's attention from the on-going conversation. Thus in embodiments, where the voice announcement is made during an on-going call, the volume of the voice announcement may be reduced for background announcement. In FIG. 2, a determination is made at conditional block 206 whether there is a call in-progress, and if so, the background announcement mode is enabled at block 208.

In the absence of an on-going call, the audible announcement may replace or complement some other call-indicating signal, for example a ring and/or vibration, typical of cellular handsets. The voice announcement in this mode may be made through a speaker of the device or at an audio output of the communications device for coupling to a headset or to an external speaker, for example to an automotive audio system via a cassette adapter.

When a call is received from an unidentified party, for example from a telephone number for which there is no associated audio clip, then the a default announcement may be played, for example “private call”. In FIG. 2, at block 210, at determination is made whether there exists an audio clip corresponding to or associated with the caller. If so, the audio clip is played at block 204. If there is no audio clip associated with the caller, then a default message is played at block 212.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a mobile wireless communication device, comprising:
receiving incoming communications at the mobile wireless communication device;
providing different audible announcements at an audio output of the mobile wireless communication device for different incoming communications when the incoming communications are received,
the different audible announcements dependent on a source of the communications received at the communication device.

2. The method of claim 1, providing different audible announcements by audibly announcing a communication address from which the incoming communication originated.

3. The method of claim 1,
storing audio clips that uniquely identify addresses corresponding to the origin of the incoming communications before receiving the incoming communications,
providing different audible announcements by playing the audio clips identifying the addresses corresponding to origin of the incoming communications when incoming communications from the corresponding addresses are received.

4. The method of claim 1, receiving an incoming communication at the mobile wireless communication device during a communication in progress at the wireless communication device, providing an audible announcement by audibly announcing a name uniquely associated with a source of the incoming communication during the communication in progress.

5. The method of claim 4, audibly announcing the name in a background of the communication in progress.

6. The method of claim 4, providing a different audible announcement on the audio output by audibly announcing a telephone number from which the incoming communication originated.

7. The method of claim 1, providing an audible announcement on the audio output during an on-going communication, the audible announcement uniquely associated with an incoming communication.

9. A method in a cellular handset, comprising:
receiving an incoming telephone call at the cellular handset during a telephone call in progress at the cellular handset,
a telephone number originating the incoming telephone call stored in the cellular handset;
providing an audible announcement on an audio output of the cellular handset uniquely associated with the incoming call when the incoming call is received.

10. The method of claim 9, receiving the incoming telephone call at the cellular handset during a telephone call in progress at the cellular handset.

11. The method of claim 10, providing the audible announcement by audibly announcing a party from which the incoming call originated.

12. The method of claim 10, providing the audible announcement by audibly announcing a telephone number from which the incoming telephone call originated.

13. The method of claim 10, storing an audio clip associated with a telephone number corresponding to an origin of the incoming telephone call before receiving the incoming telephone call.

14. The method of claim 13, providing the audible announcement by playing the audio clip associated with the telephone number corresponding to origin of the incoming telephone call.

15. The method of claim 9, storing an audio recording that uniquely identifies a telephone number corresponding to the origin of the incoming telephone call before receiving the incoming telephone call, providing the unique audible announcement by playing the audio recording identifying the telephone number corresponding to the origin of the incoming telephone call.

16. The method of claim 9, indicating that a telephone call is waiting during an on-going call by providing the audible announcement on the audio output during the on-going telephone call, the audible announcement uniquely distinguishing the call waiting from other callers.

17. A mobile wireless communication device, comprising:
wireless communication receiver;
a memory for storing a communication address and an audio clip associated therewith;
an audio output;
a processor coupled to the memory and to the audio output,
the processor for playing the audio clip at the audio output when a wireless communication originated from the communication address associated with the audio clip is received by the wireless communication receiver.

18. The device of claim 17 is a cellular handset, the communication address is a telephone number.

19. The device of claim 18, the processor for indicating that a call is waiting during an on-going call by playing the audio clip during the on-going telephone call.

20. The device of claim 17, the communication address is a telephone number, the audio clip is a name associated with the telephone number, the wireless communication is a telephone call.
